(19) United States
(12) Patent Application Publication
(10) Pub. No.: US 2004/0253033 A1
(43) Pub. Date: Dec. 16, 2004

(54) Universal flexible plural printer to plural finisher sheet integration system

(75) Inventors: Robert M. Lofthus, Webster, NY (US); Kristine A. German, Webster, NY (US); David K. Biegelsen, Portola Valley, CA (US); Joannes N. M.deJong, Hopewell Junction, NY (US); Lloyd A. Williams, Mahopac, NY (US); Warren B. Jackson, San Francisco, CA (US)

Correspondence Address: Patent Documentation Center, Xerox Corporation, 100 Clinton Ave. S., Xerox Square 20th Floor, Rochester, NY, 14644, US

(73) Assignee: Xerox Corporation.

(21) Appl. No.: 10/785,211

(22) Filed: Feb. 24, 2004

Related U.S. Application Data
(60) Provisional application No. 60/478,749, filed on Jun. 16, 2003.

(51) Int. Cl. B41J 11/42

(52) U.S. Cl. 400/582

(57) ABSTRACT

A multifunction printed sheets interface system with plural sheet input areas for receiving printed sheets from plural printers, plural sheet outputs areas for plural outputs to different sheet processing systems, a sheet position sensing system, and a sheet transporting system providing selectable sheet translation from selected plural sheet input areas to selected plural sheet outputs areas so as to provide selectable sheet feeding from selected printers to selected sheet processing systems, and selectable sheet rotation of selected sheets and selectable sheet merging in a selected sheet sequence of sheets from plural printers. The sheet transporting system has a large planar area with a multiplicity of spaced apart independently operable variable sheet feeding direction and sheet velocity sheet transports, larger than the dimensions of any sheet to be fed thereon to allow simultaneous plural sheet variable transport thereon.

This application claims the benefit of Provisional Patent Application No. 60/478,749, filed Jun. 16, 2003.

Disclosed in the embodiment herein is a flexible integration system for receiving printed sheets from plural printers and selectably directing those printed sheets to plural sheet outputs areas for plural outputs to selectably different sheet processing systems, such as different finishers, with a sheet position sensing system and a dual-axis flexible sheet transporting system (which may be integrated in a planer table device). The disclosed sheet transporting system of the embodiment provides selectable sheet translation movement and/or rotation from selected ones of said plural sheet input areas to selected ones of said plural sheet outputs areas so as to provide selectable sheet feeding from selected printers to selected sheet processing systems.

A large area of multiple spaced sheet driving elements (providing variable angle sheet driving directions) and sensors may be provided in an intelligent, adaptive, scaleable, closed-loop paper path plane, which can simultaneously enter, exit, move and re-position multiple sheets thereon. Any sheet entering at any position can be moved to any other location in the paper path plane. With a variable velocity as well as variable angle sheet movement system in the disclosed embodiment, the outputs of slower PPM printers with slower sheet velocities can be combined into a single or plural sheet output streams of higher velocities and PPM rates. Continuous feedback sensing of sheet positions can be provided.

With the disclosed embodiment, the inputs and outputs of plural lower speed printers, different paper feeders and different output devices can be more readily and flexibly combined into collated print jobs with the printing speed of a much higher speed printer.

Although not limited thereto, incorporated by reference, where appropriate, by way of background, are the following references variously relating to what have been variously called “tandem engine” printers, “parallel” printers, or “cluster printing” (in which an electronic print job may be split up for distributed higher productivity printing by different printers, such as separate printing of the color and monochrome pages), “output merger” or “interposer” systems, etc. For example, Xerox Corp. U.S. Pat. No. 5,568,246 issued Oct. 22, 1996; Canon Corp. U.S. Pat. No. 4,587,532; Xerox Corp. U.S. Pat. No. 5,570,172 to Acquaviva; T/R Systems Barry et al U.S. Pat. No. 5,596,416; Xerox Corp. U.S. Pat. No. 5,995,721 to Rourke et al; Canon Corp. Fujino U.S. Pat. No. 4,579,446; a 1991 “Xerox Disclosure Journal” publication of November-December 1991, Vol. 16, No. 6, pp. 381-383 by Paul F. Morgan; and a Xerox Aug. 3, 2001 “TAX” publication product announcement entitled “Cluster Printing Solution Announced.” One example of a Xerox Corp. sheet “interposer” patent is U.S. Pat. No. 5,389,969.

Also noted are commonly assigned Xerox Corp. U.S. Pat. No. 6,554,276, by Jackson, et al, and U.S. Pat. No. 6,607,320, by Bobrow, et al, with sheet positioners and sheet “reverters,” respectively issued on Apr. 29, 2003 and Aug. 19, 2003, both of which were filed on Mar. 30, 2001 and published on Oct. 3, 2002.

By way of an example of a variable vertical level, rather than horizontal, “universal” input and output sheet path interface connection from a single printer to a single finisher, there is Xerox Corp. U.S. Pat. No. 5,326,093. This patent is noted and incorporated as demonstrating that additional possible optional input and/or output feature here, since various different printers and third party finishers may have different sheet output levels and sheet input levels.

The exemplary multiple selectively directional (variable drive angle) sheet transports disclosed in this embodiment for two-axis sheet movement and/or rotation are the “SNIPS” systems already described an shown in Xerox Corp. U.S. Pat. No. 6,059,284 issued May 9, 2000. These SNIPS systems may thus be schematically represented herein, and need not be described in detail herein. Also noted as to somewhat similar transport systems are an MIT Draper Lab U.S. Pat. No. 4,836,119 and a Hewlett-Packard U.S. Pat. No. 6,241,242 issued Jun. 5, 2001. As disclosed in said U.S. Pat. No. 6,059,284, each SNIPS sheet drive has a spherical frictional drive ball engaging any overlying sheet, which drive ball is rotated in any desired direction and speed by two orthogonal servo-driven rollers drivingly engaging the opposite side of the ball. Overlying idler balls, pneumatic pressure or suction, or other known paper feeding normal force systems may be added, if desired, to hold the sheets down against the drive balls in addition to sheet gravity.

Various large area multiple optical sensor arrays, such as with LED's and multiple pixel photocells, with SELFOC or other collimating lenses, may be used, and are also known in the art, and in the imaging bar art, and need not be described in detail herein. Particularly noted and incorporated by reference herein is U.S. Pat. No. 6,476,376 B1 filed Jan. 16, 2002 and issued Nov. 5, 2002 by David K. Biegelsen, Bryan Preas, Lars Erik Swartz and Warren B. Jackson. FIGS. 9 and 11 thereof are noted in particular. Various large area two-dimensional optical object orientation and/or recognition sensors, such as overhead video cameras and associated software, are also known.

A specific feature of the specific embodiments disclosed herein is to provide a multifunction printed sheets interface system, comprising plural sheet input areas for receiving printed sheets from plural printers, plural sheet outputs areas for plural outputs to different sheet processing systems, a sheet position sensing system, and a sheet transporting system, said sheet transporting system providing selectable sheet translation to selectably transport sheets from selected ones of said plural sheet input areas to selected ones of said plural sheet outputs areas so as to provide selectable sheet feeding from selected printers to selected sheet processing systems.

Further specific features disclosed in the embodiment herein, individually or in combination, include those wherein said sheet transporting system additionally provides selectable sheet rotation of selected sheets; and/or wherein said sheet transporting system additionally provides selectable sheet merging in a selected sheet sequence of sheets from said plural printers to a selected said sheet processing system; and/or wherein said sheet transporting system comprises a multiplicity of spaced and independently operable variable-sheet-feeding-direction sheet transports; and/or wherein said sheet transporting system is a generally planar sheet feeding table larger than the dimensions of any sheet to be fed thereon for simultaneous plural sheet variable transport thereon; and/or wherein said sheet transporting system has a large planar area with a multiplicity: of spaced apart independently operable variable sheet feeding direction and sheet velocity sheet transports, said large planar area being substantially larger than the dimensions of any sheet to be fed thereon to allow simultaneous plural sheet variable transport thereon by said multiplicity of spaced apart independently operable variable sheet feeding direction and sheet velocity sheet transports, said sheets being sensed thereon by said sheet position sensing system, and said sheet position sensing system controlling said multiplicity of spaced apart independently operable variable sheet feeding direction and sheet velocity sheet transports.

The disclosed system may be operated and controlled by appropriate operation of conventional control systems. It is well known and preferable to program and execute imaging, printing, paper handling, and other control functions and logic with software instructions for conventional or general purpose microprocessors, as taught by numerous prior patents and commercial products. Such programming or software may, of course, vary depending on the particular functions, software type, and microprocessor or other computer system utilized, but will be available to, or readily programmable without undue experimentation from, functional descriptions, such as those provided herein, and/or prior knowledge of functions which are conventional, together with general knowledge in the software or computer arts. Alternatively, the disclosed control system or method may be implemented partially or fully in hardware, using standard logic circuits or single chip VLSI designs.

The term “reproduction apparatus” or “printer” as used herein broadly encompasses various printers, copiers or multifunction machines or systems, xerographic or otherwise, unless otherwise defined in a claim. The term “sheet” herein refers to a usually flimsy physical sheet of paper, plastic, or other suitable physical print media substrate for images, whether precut or web fed. A “copy sheet” may be abbreviated as a “copy” or called a “hardcopy.” A “print job” is normally a set of related sheets, usually one or more collated copy sets copied from a set of original document sheets or electronic document page images, from a particular user, or otherwise related.

A “finisher,” as broadly used herein, is any post-printing accessory device such as an inverter, sorter, mailbox, inserter, interposer, folder, stapler, binder, over-printer, envelope stuffer, postage machine, etc.

As to specific components of the subject apparatus or methods, or alternatives therefor, it will be appreciated that, as is normally the case, some such components are known per se in other apparatus or applications, which may be additionally or alternatively used herein, including those from art cited herein. For example, it will be appreciated by respective engineers and others that many of the particular component mountings, component actuations, or component drive systems illustrated herein are merely exemplary, and that the same novel motions and functions can be provided by many other known or readily available alternatives. All cited references, and their references, are incorporated by reference herein where appropriate for teachings of additional or alternative details, features, and/or technical background. What is well known to those skilled in the art need not be described herein.

Various of the above-mentioned and further features and advantages will be apparent to those skilled in the art from the specific apparatus and its operation or methods described in the example(s) below, and the claims. Thus, the present invention will be better understood from this description of these specific embodiment(s), including the drawing figures (which are approximately to scale) wherein:

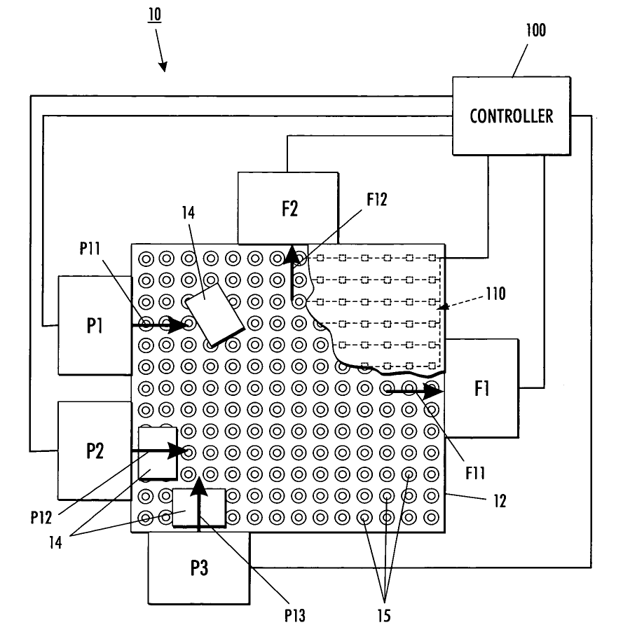

FIG. 1 (the FIGURE) schematically shows a top view of one example of the subject multifunction printed sheets interface system.

Describing now in further detail this exemplary embodiment of the FIGURE, there is shown a large area planar multifunction printed sheets interface system 10, adapted to receive an input of printed sheets 14 from schematically illustrated, otherwise conventional, printers P1, P2, P3, all feeding their printed sheets outputs to selectable different input positions on this exemplary printed sheets interface system 10. The system 10 includes a variably selectable sheet transporting system, here comprising generally planar sheet feeding table 12 larger than the dimensions of any sheet 14 to be fed thereon, with variably selectable inputs P1, P12, and/or P13 from the printers P1, P2, and/or P3, and outputs F11, F12, in this example, to conventional selectable and repositionable finisher units F1 and/or F2. The unit 10 has, over the table 12 here, a multiplicity of spaced apart and independently operable variable sheet feeding direction and sheet feeding velocity sheet transports. Those transports are provided in this example by the above-described SNIPS patent U.S. Pat. No. 6,059,284 system 15 (incorporated by reference), independently controlled by a controller 100 to drive the sheets from any input to any output, with or without sheet rotation, by their variable angle driving. The SNIPS spacings are closer than the smallest sheet to be fed. The controller 100 is also operatively connected to a large area sheet position sensor 110 distributed over the table 12 area. The controller 100 may also be operatively connected to the clustered printers P1, P2, and P3, and/or the optional finisher units F1 and F2. The number of sheet inputs and outputs, and their locations, which can be provided by the unit 10 is completely flexible. Only the software, not the hardware, need be changed for such different applications and functions.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A multifunction printed sheets interface system, comprising plural sheet input areas for receiving printed sheets from plural printers, plural sheet outputs areas for plural outputs to different sheet processing systems, a sheet position sensing system, and a sheet transporting system, said sheet transporting system providing selectable sheet translation to selectably transport sheets from selected ones of said plural sheet input areas to selected ones of said plural sheet outputs areas so as to provide selectable sheet feeding from selected printers to selected sheet processing systems.

2. The multifunction printed sheets interface system of claim 1, wherein said sheet transporting system additionally provides selectable sheet rotation of selected sheets.

3. The multifunction printed sheets interface system of claims 1, or 2, wherein said sheet transporting system additionally provides selectable sheet merging in a selected sheet sequence of sheets from said plural printers to a selected said sheet processing system.

4. The multifunction printed sheets interface system of claims 1, 2, or 3, wherein said sheet transporting system comprises a multiplicity of spaced and independently operable variable-sheet-feeding-direction sheet transports.

5. The multifunction printed sheets interface system of claims 1, 2, 3, or 4, wherein said sheet transporting system is a generally planar sheet feeding table larger than the dimensions of any sheet to be fed thereon for simultaneous plural sheet variable transport thereon.

6. The multifunction printed sheets interface system of claims 1, 2, 3, 4, or 5, wherein said sheet transporting system has a large planar area with a multiplicity of spaced apart independently operable variable sheet feeding direction and sheet velocity sheet transports, said large planar area being substantially larger than the dimensions of any sheet to be fed thereon to allow simultaneous plural sheet variable transport thereon by said multiplicity of spaced apart independently operable variable sheet feeding direction and sheet velocity sheet transports, said sheets being sensed thereon by said sheet position sensing system, and said sheet position sensing system controlling said multiplicity of spaced apart independently operable variable sheet feeding direction and sheet velocity sheet transports.
